(19) United States
(12) Patent Application Publication
(10) Pub. No.: US 2026/0027550 A1
(43) Pub. Date: Jan. 29, 2026

(54) METHOD AND SYSTEM FOR PRODUCING A SORPTION ELEMENT FOR REMOVING CARBON DIOXIDE FROM THE AMBIENT AIR

(71) Applicant: Volkswagen Aktiengesellschaft, Wolfsburg (DE)

(72) Inventors: Christine Schütz, Rethen (Vordorf) (DE); Branislav Zlatkov, Braunschweig (DE); Mareen Bauer, Dissen (DE)

(21) Appl. No.: 18/996,862

(22) PCT Filed: Jun. 21, 2023
(86) PCT No.: PCT/EP2023/066891

§ 371 Date: Jan. 17, 2025

(30) Foreign Application Priority Data
Jul. 21, 2022 (DE) 102022207442.4

(51) Int. Cl. B01J 20/30; B01D 53/04; B01D 53/62; B01D 53/82; B01J 20/32

(52) U.S. Cl. CPC B01J 20/3078; B01D 53/04; B01D 53/62; B01D 53/82; B01J 20/3007; B01J 20/3231; B01D 2257/504; B01D 2258/06

(57) ABSTRACT

Technologies and techniques for producing a sorption element for removing carbon dioxide from ambient air. The method includes providing a carbon dioxide-binding starting material and a binder, mixing them to form a homogeneous mixture, and either molding the mixture into a sorption structure or coating a support structure with the mixture. The sorption structure or coated support structure is then thermally treated to solidify and/or chemically activate the sorbent material. The disclosed method enables the production of highly efficient sorption elements with enhanced thermal and electrical conductivity, which improve adsorption and desorption processes. The disclosure also includes systems and apparatus configured to perform this method, offering reduced material usage, improved energy efficiency, and customizable geometries for diverse applications.

### RELATED APPLICATIONS

The present application claims priority to International Patent Application No. PCT/EP2023/066891 to Schütz et al., filed Jun. 21, 2023, titled “Method And System For Producing A Sorption Element For Removing Carbon Dioxide From The Ambient Air,” which claims priority to German Patent Application No. 10 2022 207 442.4, filed Jul. 21, 2022, the contents of each being incorporated by reference in their entirety herein.

### TECHNICAL FIELD

The present disclosure relates to a method and to a system for producing a sorption element for separating carbon dioxide (CO₂) from the ambient air and to a sorption element produced by way of such a method according to the preamble of the independent claims.

### BACKGROUND

So as to reduce the carbon dioxide content in the ambient air and achieve climate neutrality, it is not only necessary to decrease the carbon dioxide emissions, but also to appropriately compensate for unavoidable carbon dioxide emissions.

One option for compensating for these carbon dioxide emissions is to extract carbon dioxide from the ambient air. Such a method is also referred to as direct air capture method and is suitable for reducing the content of carbon dioxide in the atmospheric air. As an alternative or in addition, the carbon dioxide emissions can be compensated for by carbon dioxide being permanently sequestered in a storage reservoir, in particular in a rock formation, and thereby not making its way into the atmosphere.

In principle, systems and methods for extracting carbon dioxide from the ambient air are known. Such an extraction can be carried out, for example, according to the so-called “direct air capture” method, wherein the carbon dioxide can be directly extracted from the ambient air and supplied to a further process.

The majority of known methods for separating carbon dioxide from the ambient air operate based on a cyclical process, employing a combination of pressure and temperature changes. In a first process step, carbon dioxide present in the atmospheric air is bound in a sorption element, whereby the carbon dioxide content present in the atmospheric air is being reduced. The carbon dioxide bound in the sorption element can be released again in a second process step, and can either be stored or supplied to a further process in which the released carbon dioxide is needed as the starting material. As a result of the development of suitable adsorption materials and the technical implementation thereof in corresponding adsorption systems, efficient and energetically effective extraction of carbon dioxide is to be made possible.

One challenge is the development of efficient adsorption systems in which the sorption elements are technologically arranged and/or designed in such a way that, on the one hand, the adsorption and desorption of carbon dioxide progress optimally and, on the other hand, a comparatively cost-effective system concept can be implemented. In particular, the heating and cooling phases influence the process costs, while the design of the sorption element and of the process area influence the system costs. Due to their robust nature, physical sorbent materials, in particular zeolites, are particularly well-suited to serve as adsorbers for the extraction of carbon dioxide. However, such inorganic sorption materials have comparatively long heating and cooling phases between the adsorption and the subsequent desorption of the carbon dioxide, thus resulting in reduced effectiveness and causing a long cycle time and, associated therewith, increased energy consumption. Furthermore, large amounts of material are needed for the mechanical structures holding the adsorption materials, which leads to high system costs. As an alternative, it is also possible to utilize so-called chemisorbents as well as composite adsorbents as sorbent materials. Such sorbent materials can be produced, for example, by impregnation with K₂CO₃, a binary eutectic mixture (KNO₃ and LiNO₃), NaNO₃, Al₂O₃, ZrO₂, TiO₂, MnO₂, ZnO, ionic liquid (IL), and aqueous amine (that is, tetraethylenepentamine (TEPA), poly (allylamine) (PAA), polyethylene imine (PEI), ethylenediamine (EDA), diethylenetriamine (DETA), pentaethylenehexamine (PEHA), aminopropyl (AP) and similar substances.

Solutions are known from the prior art in which granules of a sorbent material are poured into an appropriate carrier structure, in particular a vessel structure in the adsorption chamber of the system.

US 2013/0312603 A1 describes a sorbent medium for cyclically taking up and giving off a gas, comprising a self-supporting structure produced by sintering a mixture of a powdered adsorbent and polyethylene particles having a molecular weight of at least 40,000 g/mol.

A method for producing a sorbent-containing coating on a carrier is known from WO 2007/054255 A1, comprising providing a sorbent and at least one adhesion-promoting component, wherein the at least one adhesion-promoting component is used in liquid or solute form. Furthermore, a carrier is provided, and the compound is applied to the carrier, wherein a temperature treatment at a temperature between 100°° C. and 500° C. and at a pressure that is reduced compared to the ambient pressure is carried out during or after the application.

U.S. Pat. No. 8,992,884 B2 describes a method for preparing crystalline aluminosilicate

zeolite from a reaction mixture containing only sufficient water to produce X zeolite. In one embodiment, the reaction mixture is self-supporting and can be shaped, if desired. In the method, the reaction mixture is heated under crystallization conditions and in the absence of an added external liquid phase so that excess liquid does not need to be removed from the crystallized product before the crystals are dried.

However, the disadvantage of the known solutions is that loose granules are comparatively cumbersome to handle during the assembly process and, when poured, may scatter next to the desired process area. Furthermore, a holding structure causes less gas to be able to flow through the process area and the adsorption of carbon dioxide to be decreased by the holding structure. In addition, the utilization of the surface area is decreased due to the holding structure and overlapping carrier structures.

### SUMMARY

Aspects of the present disclosure are directed to extracting carbon dioxide in a comparatively simple and cost-effective manner from the ambient air and to overcome at least some of the disadvantages known from the prior art.

In some examples, a method is disclosed for producing a sorption element for separating carbon dioxide from the ambient air, which comprises:
providing a carbon dioxide-binding starting material and a binder;
mixing the carbon dioxide-binding starting material with the binder to form a mixture;
shaping a sorbent medium structure from the mixture or coating a carrier structure with the mixture; and
heat treating the sorbent medium structure or the coated carrier structure, with a sorbent material (18) contained in the sorbent medium structure or the coated carrier structure being compacted and/or chemically activated.

In some examples, a sorption element is disclosed for the adsorption and desorption of carbon dioxide in the system for separating carbon dioxide from the ambient air, which may be produced by way of the methods described herein. Such a sorption element enables simplified handling during assembly and the replacement of an adsorption unit of a system for separating carbon dioxide from the ambient air. The system utilizing such a sorption element can be configured for a batch operation, during which in a sorbent receiving chamber first an adsorption of carbon dioxide, and thereafter a desorption of the stored carbon dioxide, are carried out. As an alternative, the system can also be designed as a continuous system, in which a desorption zone follows an adsorption zone, and the sorption element is transported to the particular zone. In particular, the sorption element produced by way of the method according to the invention enables a simple replacement of one or more sorption elements.

Accordingly, a better and faster heat distribution during variotherm process control is achieved, whereby the energy demand for the system can be lowered. Furthermore, an integration of an electrical heater and an increase in the thermal conductivity for an energetically optimized process control during desorption and adsorption can be achieved in a simple manner, in particular by directly coupling electrical heat output into the sorption element. Moreover, granules fixed by way of the heat treatment reduce the risk of “void formation” as a result of a random distribution of the sorbent material, and possibly insufficient filling of the process area, whereby the risk of the air current flowing through the process area without the carbon dioxide being bound by the sorbent material is minimized. In addition, the sorption element can be implemented in essentially any geometric shapes and, by dispensing with support grates, nets or other holding elements, can have a simpler and more cost-effective design. Furthermore, the assembly of the system is facilitated since no sorbent media must be poured into the cavities of the support structure of the sorption element during the assembly process.

In some examples, a production system is disclosed for producing a sorption medium. The production system may comprise: means for providing a carbon dioxide-binding starting material and a binder; a mixing device for mixing the carbon dioxide-binding starting material with the binder to form a mixture; a shaping device for shaping a sorbent medium structure from the mixture or a coating device for coating a carrier structure with the mixture; and a heat treating device for heat treating the sorbent medium structure or the coated carrier structure, wherein a sorbent medium contained in the sorbent medium structure or in a coating of the carrier structure is being compacted and/or chemically activated.

Such a production system makes it possible in a simple manner to produce a sorption element according to the invention. In particular, the production process can be substantially automated by way of such a production system, whereby the cycle times and the manufacturing costs for the sorption element can be minimized.

The various specific embodiments disclosed herein can advantageously be combined with one another, unless they are implemented differently in the individual case.

### BRIEF DESCRIPTION OF THE DRAWINGS

Aspects of the present disclosure will be described hereafter in exemplary embodiments based on the associated drawing. In the drawing:

FIG. 1 shows a system for separating carbon dioxide from the ambient air, according to some aspects of the present disclosure;

FIG. 2 shows a first flow chart for carrying out a method according to the invention for producing a sorption element for separating carbon dioxide from the ambient air, according to some aspects of the present disclosure;

FIG. 3 shows a second flow chart for carrying out a method for producing a sorption element for separating carbon dioxide from the ambient air, according to some aspects of the present disclosure;

FIG. 3 shows a third flow chart for carrying out a method for producing a sorption element for separating carbon dioxide from the ambient air, according to some aspects of the present disclosure;

FIG. 4 shows a sorption element produced by way of a method according to some aspects of the present disclosure; and

FIG. 5 shows a production system for producing a sorption element according to some aspects of the present disclosure.

### DETAILED DESCRIPTION

As used herein, a carbon dioxide-binding starting material refers to a substance capable of physically and/or chemically adsorbing carbon dioxide from ambient air at temperatures ranging from −20° C. to 50° C., preferably from 0° C. to 30° C., and at ambient pressure. The bound carbon dioxide can be released at higher temperatures, lower pressure, or under vacuum conditions. A binder refers to an auxiliary agent that facilitates the permanent bonding of the sorption element of the starting material either to itself or to a carrier structure. Preferably, the binder is included in the starting material to aid in producing the sorption element.

The method described in the present disclosure enables simplified handling during assembly and facilitates the replacement of an adsorption unit after maintenance or sorbent exchange in a system designed to separate carbon dioxide from ambient air. The system can operate in batch mode, wherein carbon dioxide adsorption is followed by desorption within a sorbent receiving chamber. Alternatively, the system may function continuously, with a desorption zone following an adsorption zone, where the sorption element is transported between zones. The sorption element produced by this method allows for easy replacement and supports a homogeneous, high packing density within the system volume, reducing the need for holding frames, sorbent carriers, or additional components such as nets. This design enhances the contact between carbon dioxide-containing air and the sorbent material, maximizing surface area utilization during adsorption and desorption. Dispensing with obstructive holding elements further optimizes the flow path. Additionally, the self-supporting sorbent medium structure reduces weight and manufacturing costs while allowing for diverse geometric configurations, including free-form surfaces, recesses, curvatures, and protrusions. This flexibility minimizes maintenance time and simplifies sorbent replacement.

The sorbent material is applied to a carrier structure with superior thermal and electrical conductivity compared to the sorbent material, enabling efficient heat distribution during variotherm process control and reducing energy demand. Electrical heaters and/or heat exchangers can be integrated into the carrier structure, facilitating optimized thermal processes during adsorption and desorption. Granules fixed by heat treatment reduce void formation caused by uneven distribution or insufficient filling, ensuring consistent contact between the sorbent material and the air current. Suitable materials for the carrier structure include aluminum, copper, stainless steel, and graphite, among others.

Additional features described in the dependent claims provide advantageous refinements and enhancements to the method for producing a sorption element for carbon dioxide separation.

In one refinement, the sorption element undergoes surface treatment, such as micro-peening or cleaning, after heat treatment. This step removes dust and unattached particles, which could otherwise reduce the sorbent material's capacity for carbon dioxide. Surface treatment can also open closed pores, increasing adsorption capacity.

In another enhancement, the starting material may be supplied as powder, granules, or spheres of carbon dioxide-binding sorbent material. Finely ground powder ensures homogeneous mixing with the binder, facilitating uniform coating of the carrier structure and improving adsorption efficiency. Spheres can also be mixed with the binder to form a self-supporting sorbent medium structure through heat treatment, such as sintering.

Inorganic sorbent materials are particularly preferred due to their higher binding capacity and efficiency compared to organic materials. However, organic polymer compound materials may also be used, alone or in combination with inorganic materials.

One or more additives may be included to enhance bonding between the starting material and the carrier structure or among sorbent medium components. Additives can activate the sorbent medium, improving its carbon dioxide absorbency.

The carrier structure may include an additional surface on at least one side, which can be used for heating connections, such as inductive heating, ensuring uniform temperature distribution. Alternatively, the additional surface may serve as a coolant channel for thermal regulation or as a heat exchanger. This surface can remain uncoated to facilitate handling or provide an electrical contact.

The additional surface may also accommodate electrical heating elements, enabling rapid and effective heating of the sorption element.

In another advantageous embodiment, the sorption element comprises multiple sorbent elements bonded to the carrier structure and/or each other. This configuration creates a close-meshed structure, allowing efficient adsorption and subsequent desorption of carbon dioxide.

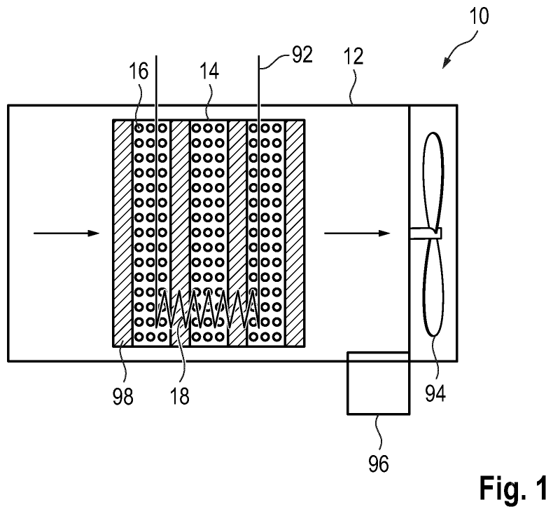

FIG. 1 shows a direct air capture system 10 known from the prior art for separating carbon dioxide from ambient air in a schematic representation. The system comprises a process area 12 in which an adsorption chamber 14 for adsorbing carbon dioxide is arranged. The adsorption chamber 14 includes at least one sorption element 16 containing a spherical sorbent material 18, which in this case is a so-called chemisorbent that chemically binds carbon dioxide and removes it from the ambient air. In particular, amine-functionalized, porous materials are suitable sorbent materials 18. The sorbent material 18 is maintained in the form of a packed bed within the adsorption chamber 14. For this purpose, a support frame 98 is provided to receive the sorbent material, into which the sorbent material 18 is poured. The adsorption chamber 14 located in the process area 12 can be heated by a temperature control unit 92, particularly through a heat exchanger. The process area 12 has an inlet through which ambient air can flow into the process area 12. The system 10 also comprises a flow generator 94, specifically a fan, for conducting an air current of ambient air through the process area 12. Additionally, a pressure reduction unit 96 is provided in the process area 12 to at least partially evacuate the area and lower the absolute pressure in the process area 12 to below the ambient pressure.

The process area 12 further includes a first outlet, which is preferably connected to the surroundings, and a second outlet, through which a gas flow rich in carbon dioxide can be discharged from the process area 12. The inlet, the first outlet, and the second outlet can be sealed by corresponding inlet and outlet valves to create a gas-tight seal between the process area 12 and the surroundings. The carbon dioxide from the ambient air is first absorbed in the adsorption chamber 14 by the sorbent material in the known manner and, in a subsequent desorption process step, is released from the sorbent material again through temperature and pressure changes or by supplying water vapor.

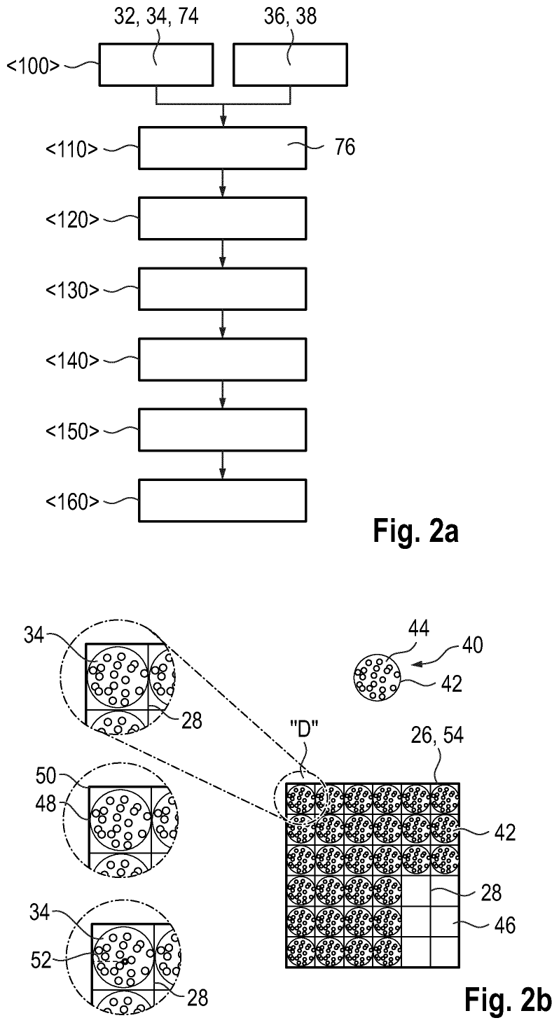

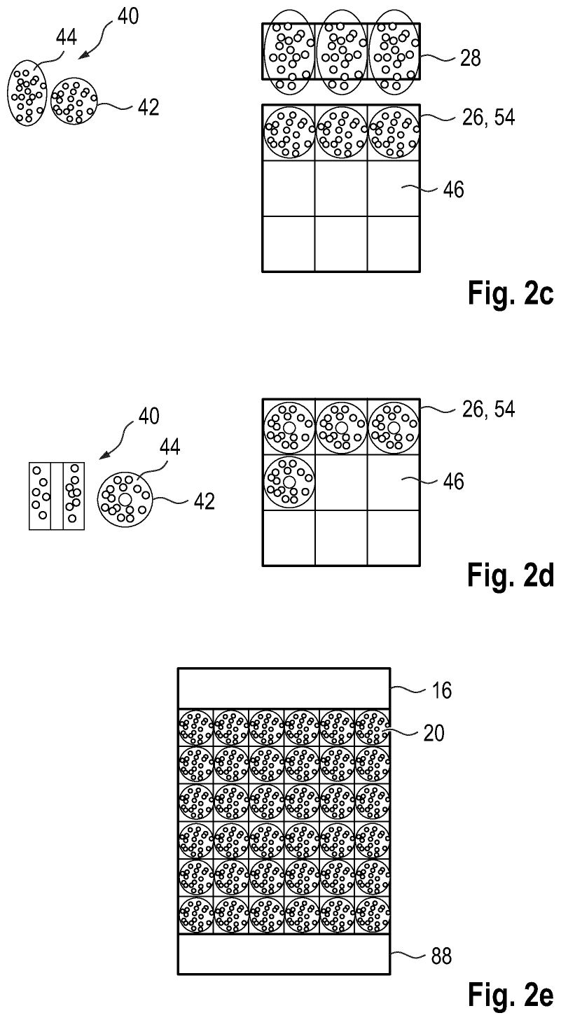

FIG. 2a shows a first example of a method according to the invention for producing a sorption element 16 based on a physisorbent material for such a system 10. The method comprises providing <100> a carbon dioxide-binding starting material 74, which is preferably in the form of a powder 32 of a zeolite, and providing a binder 36. The starting material 74 and the binder 36, along with optionally one or more additives 38, are mixed in a method step <110> to form a substance mixture 76, with the goal of achieving as homogeneous a mixture as possible. In a subsequent method step <120>, individual sorbent material parts, for example, spherical granules 34, are produced, which can encompass extrusion, granulation, powder injection molding, and other method steps. In a subsequent method step <130>, the spherical granules 34 or the mixture 76 can optionally be dried. The drying process is followed by a process step <140>, during which the carrier structure 26 is fitted with the mixture 76 or an intermediate product produced from the mixture, such as spherical granules 34, to form as dense a sorbent medium structure 20 as possible. This process step is followed by a heat treatment <150>, which, in particular, includes a sintering process for bonding the mixture 76 or the intermediate product with the carrier structure 26 and/or a thermal activation of the sorbent material 18. Thereafter, a quality control step <160> of the sorption element 16 can be carried out, with a treatment process provided before or after to remove dust, production residues, and loose particles from the sorption element.

FIG. 2a shows method steps of the disclosed invention. The sorbent material 18 is mixed in powder form with one or more binders 36 and optionally further additives 38 and is homogenized. Depending on the final geometry of the sorption elements 16 (strand profile, plate shape, free-form surface, sandwich, and the like), an appropriate technology for shaping the sorbent medium structure 20 is used. After the sorbent elements 40 have been shaped, a drying step can optionally take place. Thereafter, sorbent elements 40, which prior to the heat treatment process are also referred to as green parts, are attached to the carrier structure 26 and optionally pressed on lightly. Finally, the carrier structures 26, including the sorbent elements 40, are heat treated in a furnace, which can be designed as a continuously operated conveyor furnace or a batch furnace. During the heat treatment, a sintering process is carried out, during which the sorbent elements 40 are bonded to the carrier structure 26 and/or to one another. Thereafter, a quality control step is carried out, along with an optional treatment process, in particular for washing and/or dedusting the sorption elements 16.

FIG. 2b furthermore shows a specific embodiment of the sorption element 16 according to the invention. Spherical sorbent elements 40 are shown, which are, in particular, produced from granules, for example, by means of granulation or extrusion. The granules 34 comprise a material matrix 42, which can be created using different formulations and material types. At the microscopic level, various pore sizes occur in the incident flow region of a sorbent matrix 44. As was briefly described above, the spheres 40 of the sorbent material 18 are attached, after production, to a sorbent medium structure 20 using an appropriate device, so that the individual sorbent elements 40 occupy or become positioned in a free spot 46 at the sorbent medium structure 20. In simpler terms, the sorbent medium structure 20 represents a net structure 28 having a defined mesh size, which can be made of metal or an electrically and thermally conducting composite material.

The sorbent medium structure 20 can generally be designed to be planar or curved, tilted, or take on any free-form surface area. In combination with the sorbent elements 40, a sandwich structure having an essentially unlimited thickness, dictated by the particular application, can be created.

The details in FIG. 2c show an enlarged illustration of a sorbent element 40, which was fitted onto a carrier structure 26, in particular, a net structure 28. FIG. 2c shows an initial state of the sorbent elements 40 on the carrier structure 26 prior to the heat treatment, that is, before the sintering process. FIG. 2b discloses the state of the sorbent elements 40 after the heat treatment, wherein a rigid joint 48 is established between the carrier structure 26 and the sorbent material 18, without influencing the porosity of the sorbent material 18. The micropores of the sorbent material 18 must remain open to allow an air current to flow through the sorbent material 18. The corners 50 of the carrier structure 26 should remain open to ensure favorable and controlled airflow during the process control.

FIG. 2d shows another design embodiment, wherein a rod is additionally formed at the net structure 28. Essentially, spheres 40 of the sorbent material 18 of any geometry are placed on the rod and are thus fixed. The embodiment shown in FIGS. 2b to 2e offers the advantage that the sorbent material 18 makes direct contact with a substrate, which significantly improves electrical and thermal conductivity, making process control during desorption and adsorption more energetically attractive. Alternatively, the sorbent material 18 can also be designed in the form of sorbent pellets. In particular, extrusion, granulation, or powder injection molding can be used to produce such sorbent pellets. With respect to the production methods, the same procedure as described in the preceding paragraphs applies. In this process, the carrier structure 26 is fitted with sorbent pellets.

A sleeve-shaped embodiment of the sorbent element 40 shown in FIG. 2d would be another embodiment according to the disclosed invention. This embodiment would have the advantage of increasing the active surface area of the material and shortening diffusion paths, which can facilitate and expedite desorption. The sorbent elements 40 in the form of a sleeve could, for example, be produced by extrusion or powder injection molding. The production method would follow the same procedure as described in the preceding paragraphs.

In FIG. 2e, it is assumed that a sorbent medium support frame structure 26, 54 has additional surfaces 88 on one or more sides. These additional surfaces 88 can, for example, be used as connections for implementing heating of the carrier structure 26, thereby achieving a more homogeneous desorption temperature more quickly. Another advantage would be a simplified assembly of the adsorption chamber 14 for the system 10.

For a preferred solution from a production point of view, the sorbent medium support frame structure 26, 54 can be joined in a tool as an insert part, and the material matrix of the sorbent material 18 can be applied thereafter. Subsequently, a drying step may optionally follow, followed by a heat treatment, compaction, or sintering of the sorption material 18 on the sorbent medium support frame structure 26, 54. Alternatively, or in addition, the additional surface 88 can be designed, from a production point of view, so that a liquid medium can be present in a closed circuit and be used for heating or cooling the carrier structure 26 and the sorbent material 18 connected to the carrier structure 26.

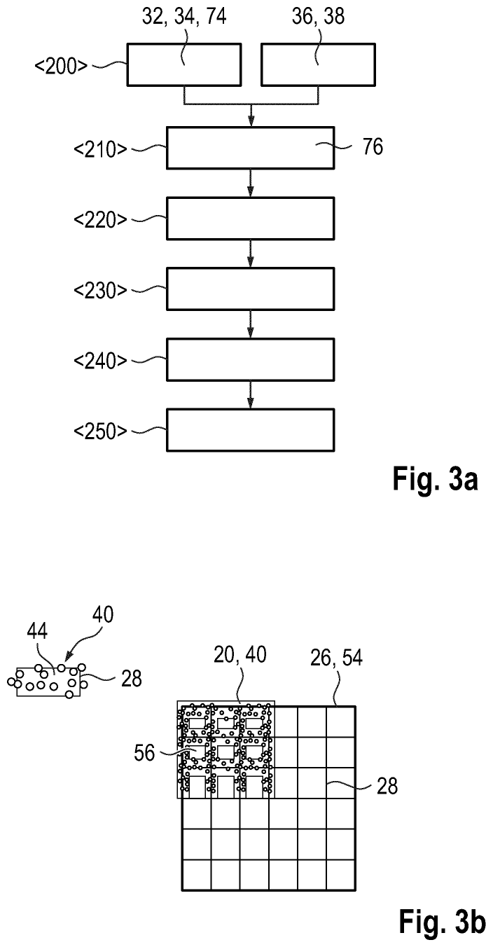

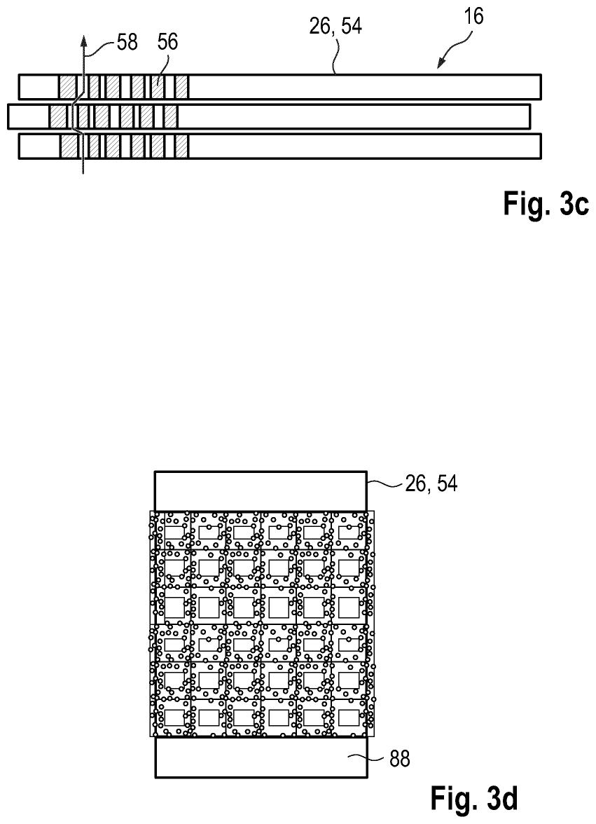

FIG. 3a shows a second exemplary embodiment of a method according to the invention for producing a sorption element 16 based, for example, on a physisorbent material for such a system 10. FIG. 3 describes the method steps for producing a sorption element 16 according to the invention. In a method step <200>, an inorganic carbon dioxide adsorber material, such as zeolite, which is preferably in powder form, and one or more binders 36 and optionally additives 38 are provided and, in a method step <210>, mixed and homogenized. The material mixture 76 of the sorbent element 40 produced is attached and/or applied to a carrier structure 26 in a method step <220> using different coating methods. After the coating step, a drying step can optionally be carried out in a method step <230>. Thereafter, the sorbent medium structures 20, including the sorbent material 18, are heat-treated in a furnace in a method step <240>, activated, and thereby joined together without residue. Finally, quality control <250> is carried out, as well as an optional treatment step, such as washing, dedusting, and the like.

FIG. 3b shows a sorbent medium support frame structure 26, 54. Put more simply, it represents a net structure 28 with a defined mesh size, which can be made of metal or an electrically or thermally conducting composite material, with inorganic composite materials, such as ceramics, being preferred since they have the necessary temperature resistance for the heat treatment.

The homogenized material mixture 76 can be created using different formulations and material types. At the microscopic level, varying pore sizes can occur in the incident flow region of the sorbent matrix 44. The preferred pore sizes and their distribution are primarily dependent on the specific application. The sorbent medium support frame structure 26, 54 can be designed to be planar, curved, tilted, or to take on any free-form surface area. In combination with the sorbent material 18, a structure with various wall thicknesses can be implemented or adapted to meet the application requirements.

The coating process can be carried out in a variety of ways regarding process control. To achieve the desired coating results, it is essential that the pore openings 56 in the sorbent medium support frame structure 26, 54 remain accessible after the coating process; that is, the binder 36 must be completely degraded during the sintering process. The pore openings 56 allow an air current 58 to flow through the sorption element 16, enabling the carbon dioxide contained in the air current to be captured in the sorption element by adsorption.

FIG. 3c shows a representative illustration of a composition of multiple sorbent medium support frame structures 26, 54, which are stacked in an offset manner so that the pore openings 56 remain uncovered. This arrangement ensures good airflow across a maximum sorbent surface while preventing direct tunnel-like flow through the sorption element 16.

FIG. 3d shows a sorbent medium support frame structure 26, 54 that has an additional surface 88 on at least one side. This additional surface 88 can, for example, serve as a connection for an electrical heating means 90. Furthermore, the additional surface can include at least one coolant channel for controlling the temperature of the carrier structure 26. For this purpose, a liquid or gaseous medium is circulated through the coolant channel to heat or cool the carrier structure 26 and the sorbent material 18 connected to it accordingly.

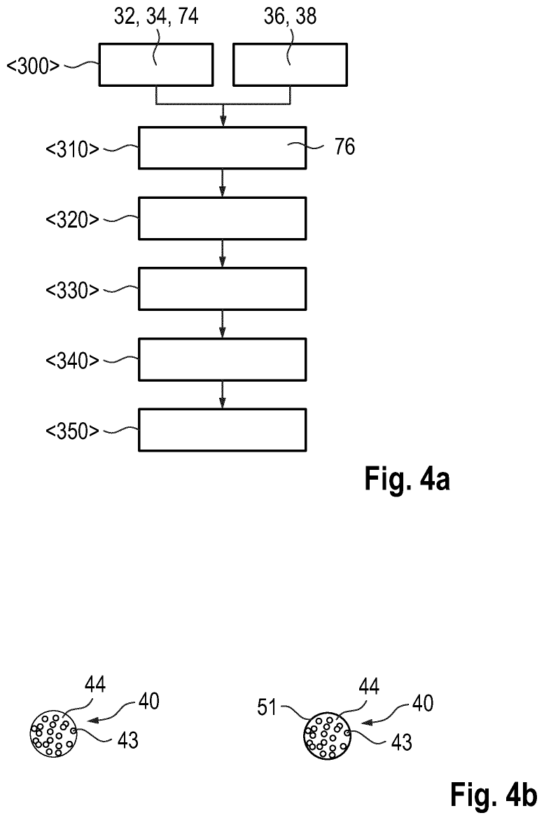

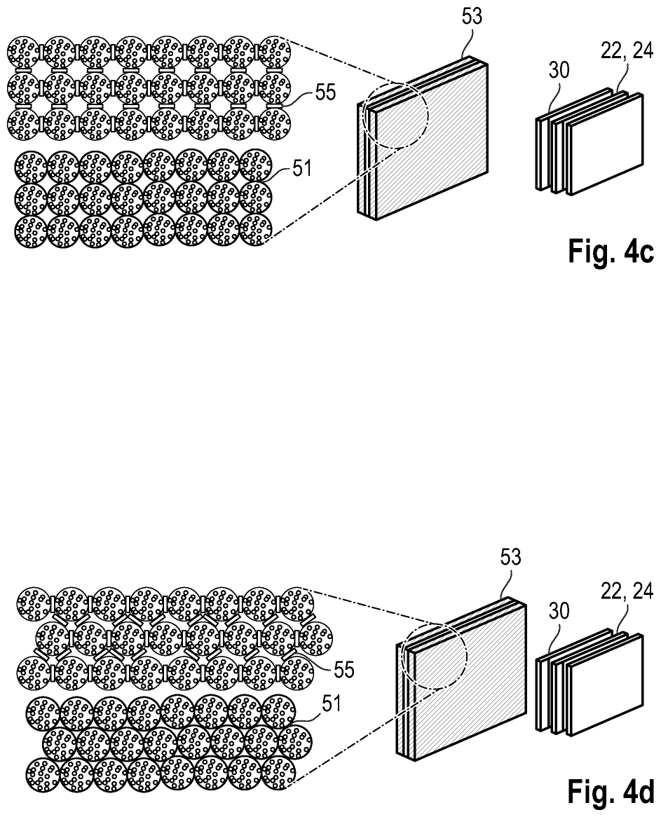

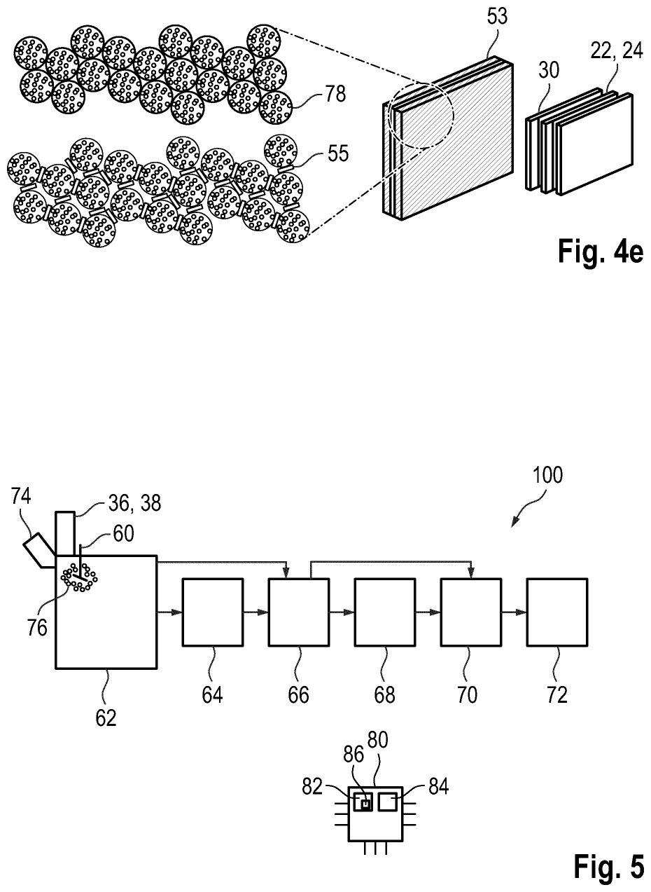

FIG. 4a shows another exemplary embodiment of a method according to the invention for producing a sorption element 16 for such a system 10.

FIG. 4a illustrates method steps of a further embodiment of a method according to the invention for producing a sorption element 16 based, for example, on a physisorbent material. In a method step <300>, an inorganic carbon dioxide-binding sorbent material 18, in particular a zeolite, which is preferably in powder form, is provided as the starting material 74, along with a binder 36 and optionally further additives 38. In a method step <310>, the starting material 74 is mixed and homogenized with the binder 36, and optionally with the additives 38. Depending on the final geometry of the sorption element 16, an appropriate technology for shaping is used, and in a method step <320>, the sorption element 16 is shaped. The joined granule structure is thus present without carrier structures and can generally be designed to be planar or curved, tilted, or in any free-form surface area and thickness. In combination with differently designed intermediate layers, such as those for cooling or heating, a sandwich structure with essentially unlimited thickness-dictated by the particular application-can be created. This necessitates the addition of a coating process to the process control. After the shaping step, a drying step can optionally occur in a method step <330>. Thereafter, the sorption elements 16, referred to as green parts prior to heat treatment, are poured into a mold and held there. Finally, the mold holders and sorption elements 18 are heat treated or activated in a furnace in a method step <340>. Subsequently, in a method step <350>, quality control and an optional washing and/or dedusting step are carried out.

FIG. 4b shows spherical sorbent elements 40, which in the present exemplary embodiment are designed as so-called spherical granules 34. These granules 34 can be produced, for example, by means of powder injection molding or granulation. In principle, these granules 34 comprise a material matrix 42, which can be produced using different formulations and material types. At the molecular level, different pore sizes can occur in the incident flow region of the sorbent matrix 44. FIG. 4c shows another embodiment related to the disclosed invention. The material matrix formulation is prepared so that a liquid phase forms on the granules' surface during heat treatment. This liquid phase enables a bond 51 without closing the surface pores of individual granules 34. As described in FIG. 4a, the granules are added, after production, as packing in an open mold 53 and are heat treated, resulting in a fixed contact formation after cooling. This creates a self-supporting sorbent medium structure 30, which can be designed, in particular, in the form of plates 22 or lamellae 24.

FIG. 4c shows an ordered packing of the granules 34 after the heat treatment. A so-called sinter neck 55 forms between the individual granules 34. Complete wetting occurs on the surface of the granules 34, which become semiliquid during the heat treatment and essentially coalesce (sinter) the individual granules 34 after cooling.

FIG. 4d shows a disordered packing of the granules 34 after the heat treatment. A so-called sinter neck 55 also forms between the individual granules 34. FIG. 4e shows another spatially disordered packing of the granules 34 after the heat treatment. A so-called sinter neck 55 forms between the individual granules 34. Complete wetting occurs on the surface of the granules 34, which become semiliquid during the heat treatment and essentially coalesce (sinter) the individual granules 34 after cooling.

In principle, the diameters of the granules 34 may differ in the exemplary embodiments shown in FIGS. 2 to 4. Furthermore, numerous variations in terms of size distribution may be possible. In addition, further material combinations, for example with a chemisorbent, are also conceivable in all variants.

FIG. 5 shows a production system 100 for producing a sorption element 16 according to the invention. The production system 100 comprises means for providing a preferably inorganic carbon dioxide-binding starting material 74 (physisorbent) and a binder 36. The production system 100 can additionally comprise means for providing additives 38. The means for providing may, in particular, comprise storage receptacles into which the starting material 74, the binder 36, and optionally the additive 38, preferably in the form of powder or granules, are poured. Alternatively, the binder 36 and/or the additive 38 can also be supplied in the form of a liquid. The production system 100 furthermore comprises a mixing device 60 for mixing the carbon dioxide-binding starting material 74 with the binder to form a mixture 76. This can, for example, be a stirring device, a shaking device, or the like. The production system 100 also comprises a shaping device 62 for shaping a sorbent medium structure 20 from the mixture 76 or a coating device for coating a carrier structure 26 with the mixture 76. The shaping device is a corresponding production machine that is suitable for carrying out shaping or coating and may, in particular, comprise a granulator, extruder, injection molding machine, or coating unit, as well as other production machines. Additionally, the production system 100 can optionally comprise a drying device 66 to dry the intermediate product produced by the shaping device 62. The production system 100 may also include a fitting device 68 for fitting the carrier structure 26 with sorbent elements 40.

The production system 100 furthermore comprises a heat treatment device 70 for heat treating the sorbent medium structure 20 or the coated carrier structure 26, wherein a sorbent material contained in the sorbent medium structure 20 or in a coating of the carrier structure 26 is compacted and/or chemically or thermally activated. The heat treatment device 70 in particular comprises a sintering furnace. The production system 100 can also include a control station for checking the produced sorption element 16, as well as a treatment device 72, for example, for cleaning the sorption element 16 and the like.

The production system 100 furthermore comprises a control unit 80 that includes a memory unit 82 and a processing unit 84, wherein machine-readable program code 86 is stored in the memory unit 82. When this program code 86 is executed by the processing unit 84, the control unit 80 manages the method described in the preceding paragraph for producing a sorption element 16.

### LIST OF REFERENCE NUMERALS

10 direct air capture system
12 process area
14 adsorption chamber
16 sorption element
18 sorbent material
20 sorbent medium structure
22 plate
24 lamella
26 carrier structure
28 net structure
30 self-supporting sorbent medium structure
32 powder
34 granules
36 binder
38 additive
40 sorbent element
42 material matrix
44 sorbent matrix
46 free spot
48 joint
50 corner
51 bond
52 rod
53 open mold
54 support frame structure
55 sinter neck
56 pore opening
58 air current
60 mixing device
62 shaping device
64 coating device
66 drying device
68 fitting device
70 heat treating device
72 cleaning device
74 starting material
76 mixture
78 spheres
80 control unit
82 memory unit
84 processing unit
86 program code
88 additional surface
90 electrical heating means
92 temperature control unit
94 flow generator
96 pressure reducing unit
98 support frame
100 production system

1-10. (canceled)

11. A method for producing a sorption element for separating carbon dioxide from ambient air, comprising:
providing a carbon dioxide-binding starting material and a binder;
mixing the carbon dioxide-binding starting material with the binder to form a mixture;
shaping the mixture into a sorbent medium structure or coating a carrier structure with the mixture; and
heat treating the sorbent medium structure or the coated carrier structure, wherein the sorbent medium structure or the coating includes a sorbent material that is compacted and/or chemically activated.

12. The method of claim 11, further comprising post-treating an outer surface of the sorption element after the heat-treating step, wherein the post-treating step removes dust, residues, or loose particles from the outer surface.

13. The method of claim 11, wherein the carbon dioxide-binding starting material comprises a powder, granules, or spheres of a carbon dioxide-binding sorbent material.

14. The method of claim 11, further comprising mixing one or more additives with the carbon dioxide-binding starting material and the binder to form the mixture, wherein the one or more additives improve bonding between the sorbent medium structure and the carrier structure or enhance the carbon dioxide absorbency of the sorbent medium structure.

15. The method of claim 11, wherein the carrier structure includes an additional surface on at least one side.

16. The method of claim 15, wherein the additional surface is free of a coating and is configured to couple an electrical heating means into the carrier structure, facilitating uniform heating of the sorption element.

17. The method of claim 15, wherein the additional surface includes at least one coolant channel configured to control the temperature of the carrier structure.

18. The method of claim 11, wherein the sorption element comprises a plurality of sorbent elements, each of the plurality of sorbent elements being bonded to the carrier structure and/or to at least one other sorbent element to form a self-supporting sorbent medium structure.

19. A sorption element for adsorbing and desorbing carbon dioxide in a system for separating carbon dioxide from ambient air, the sorption element comprising:
a sorbent medium structure formed from a mixture of a carbon dioxide-binding starting material and a binder, wherein the sorbent medium structure includes a sorbent material that is compacted and/or chemically activated through heat treatment.

20. The sorption element of claim 19, wherein an outer surface of the sorption element is post-treated to remove dust, residues, or loose particles.

21. The sorption element of claim 19, wherein the carbon dioxide-binding starting material comprises a powder, granules, or spheres of a carbon dioxide-binding sorbent material.

22. The sorption element of claim 19, further comprising one or more additives mixed with the carbon dioxide-binding starting material and the binder, wherein the one or more additives improve bonding within the sorbent medium structure or enhance the carbon dioxide absorbency of the sorbent medium structure.

23. The sorption element of claim 19, wherein the sorbent medium structure is coated onto a carrier structure, and the carrier structure includes an additional surface on at least one side.

24. The sorption element of claim 23, wherein the additional surface is free of a coating and is configured to couple an electrical heating means into the carrier structure, facilitating uniform heating of the sorption element.

25. The sorption element of claim 23, wherein the additional surface includes at least one coolant channel configured to control the temperature of the carrier structure.

26. The sorption element of claim 19, wherein the sorbent medium structure comprises a plurality of sorbent elements, each of the plurality of sorbent elements being bonded to the carrier structure and/or to at least one other sorbent element to form a self-supporting sorbent medium structure.

27. A production system for producing a sorption element for separating carbon dioxide from ambient air, comprising:
a storage unit configured to provide a carbon dioxide-binding starting material and a binder;
a mixing unit configured to mix the carbon dioxide-binding starting material with the binder to form a mixture;
a shaping unit configured to shape the mixture into a sorbent medium structure or a coating unit configured to coat a carrier structure with the mixture; and
a heat treatment unit configured to heat treat the sorbent medium structure or the coated carrier structure, wherein a sorbent material within the sorbent medium structure or the coating is compacted and/or chemically activated during the heat treatment.

28. The production system of claim 27, further comprising a post-treatment unit configured to treat an outer surface of the sorbent medium structure or the coated carrier structure after the heat treatment, wherein the post-treatment unit removes dust, residues, or loose particles from the outer surface.

29. The production system of claim 27, wherein the carbon dioxide-binding starting material comprises a powder, granules, or spheres of a carbon dioxide-binding sorbent material, and the shaping unit is configured to process the mixture into the desired geometry based on the starting material's form.

30. The production system of claim 27, wherein the carrier structure includes an additional surface on at least one side, and the additional surface is configured to couple an electrical heating element into the carrier structure to facilitate uniform heating of the sorption element during the heat treatment.
